(19) United States
(12) Patent Application Publication
(10) Pub. No.: US 2003/0009305 A1
(43) Pub. Date: Jan. 9, 2003

(54) Flexible, extensible, and portable testing platform

(76) Inventor: John S. Eden, Roseville, CA (US)

Correspondence Address: HEWLETT-PACKARD COMPANY, Intellectual Property Administration, P.O. Box 272400, Fort Collins, CO, 80527-2400, US

(21) Appl. No.: 09/880,329

(22) Filed: Jun. 12, 2001

(51) Int. Cl. G06F 19/00

(52) U.S. Cl. 702/119

(57) ABSTRACT

A testing platform comprising a test execution engine, test routines, and functional components that adapt the test execution engine and test routines to various hardware and software interfaces, shielding the test execution engine and test routines from a multitude of hardware and software dependencies.

### TECHNICAL FIELD

The present invention is related to software, firmware, and hardware testing and, in particular, to a test execution and test development environment, or testing platform, that provides for development of portable test routines, by shielding test routines from specific hardware and software interfaces, and that itself can be easily ported and enhanced to facilitate testing of many different types of hardware and software components while running within a multitude of different computing environments.

### BACKGROUND OF THE INVENTION

Automated testing is currently a major component of the design, manufacture, configuration, and installation of hardware, firmware, software, and complex hybrid systems. Although designers, manufacturers, configuration experts, and installers strive to develop reliable components and systems, it is nearly impossible, within commercial economic constraints, to achieve provable correctness and robustness without an iterative approach in which problems and deficiencies discovered via testing at one stage are corrected in a subsequent stage. A sizable body of theory and technology related to testing and quality assurance has evolved along with the evolution of computers and software technologies. Designers, manufacturers, configuration experts, and installers routinely develop sophisticated automated testing software for testing software routines and systems, firmware routines, hardware components, and complex components comprising combinations of software, firmware, and hardware.

FIG. 1 abstractly illustrates a common, generic testing environment in which an automated test is run. An automated test program 102 executes within a computer resource 104, interfacing to, and exchanging data with, an operating system 106 that provides system services by interfacing to hardware and firmware computing components 108 in the computing resource. Hardware and firmware components include communications controllers and device drivers that allow the computing resource 104 to interface to, and exchange data with, external entities that include user input/output (“I/O”) devices 110 such as display terminals and keyboards, data storage and retrieval devices 112 including external disk drives, disk arrays, and database servers, and external entities 114 under test by the automated test program 102. When the automated test program 102 tests another software component, the software component under test 116 may also be executed in association with the operating system 106 and underlying hardware and firmware components 108. In addition, additional programs 118 may run in association with either the program under test 116, in association with the automated test program 102, or in association with both program under test and with the automated test program. Examples of associated programs include database management systems, simulators, and specialized drivers. Thus, the environment 100 in which an automated test program 102 runs may be quite complex, and may involve numerous hardware/hardware, hardware/software, and software/software interfaces.

Great time and effort may be involved in developing test programs. In many cases, test programs are developed in a relatively ad hoc manner to include dependencies on many different hardware/hardware, hardware/software, and software/software interfaces. For example, it is quite common to directly embed operating-system-specific system calls directly within an automated test program. Embedding system calls directly within the automated test program may represent an efficiency or expediency with regard to developing a test routine for of a particular component, but may, in turn, represent a burdensome dependency if the automated test program is attempted to be applied to testing a different type of component or is attempted to be ported to execute under a different operating system from that for which the automated test program was initially developed.

Many possible interface dependencies are visible in FIG. 1. As discussed above, the automated test program 102 may be quite dependent on the interface 120 to the operating system 106. The automated test program 102 may additionally depend on a particular interface 122 used to access and exchange data with a hardware component 114 under test. The automated test program may depend on a particular user I/O interface 124, including a protocol by which data exchanged with an external I/O device 110 is interpreted by the automated test program 102. The automated test program 102 may also depend on high-level interfaces, not shown in FIG. 1, between the automated test program 102 and a program under test 116 or an associated, concurrently running program 118.

Embedded hardware/hardware, hardware/software, and software/software interface dependencies in an automated test program may inhibit or prevent using the automated test program to test components other than the specific components for which it is designed, and may inhibit execution of the automated test program in environments different from the environment 100 for which the automated test program is developed. A non-modular design of the automated test program 102 may inhibit or prevent the automated test program from being enhanced or extended to execute different types of tests or to execute tests with different frequencies, ordering, and configuration.

Attempts have been made to generalize automated test programs, so that the automated test programs can be enhanced, or extended, ported to different hardware and operating system environments, and employed to test a variety of different software or hardware components. However, currently available automated test programs and automated test program environments have not achieved a desirable level of enhancibility, portability, and applicability. For this reason, designers, manufacturers, configuration experts, and installers have recognized the need for a modular and easily enhanced, portable, adaptable, and generalized testing platform to serve as an environment for running automated test programs.

### SUMMARY OF THE INVENTION

One embodiment of the present invention is en extensible, adaptable, and portable testing platform comprising a test execution engine and one or more automated test routines, the test execution engine and automated test routines shielded from hardware/hardware, hardware/software, and software/software dependencies by abstract functional components, specific instances of which are adapted to interface to particular hardware and software resources and components in the testing environment. The test execution engine includes a relatively small internal execution loop that is free from dependencies on the computing resource within which the test execution engine runs, and is free from dependencies on particular automated test programs, user I/O interfaces, and interfaces to external computing resources and components. Likewise, the one or more automated test routines can be written without dependencies on the computing resource in which they are run or on user I/O interfaces, component interfaces, and other such dependencies. The testing platform is therefore easily enhanced, easily adapted to test entities unforeseen at the time that the testing platform is developed, and is easily transported to a myriad of different computing resource environments.

### BRIEF DESCRIPTION OF THE DRAWINGS

FIG. 1 abstractly illustrates a common, generic testing environment in which an automated test is run.

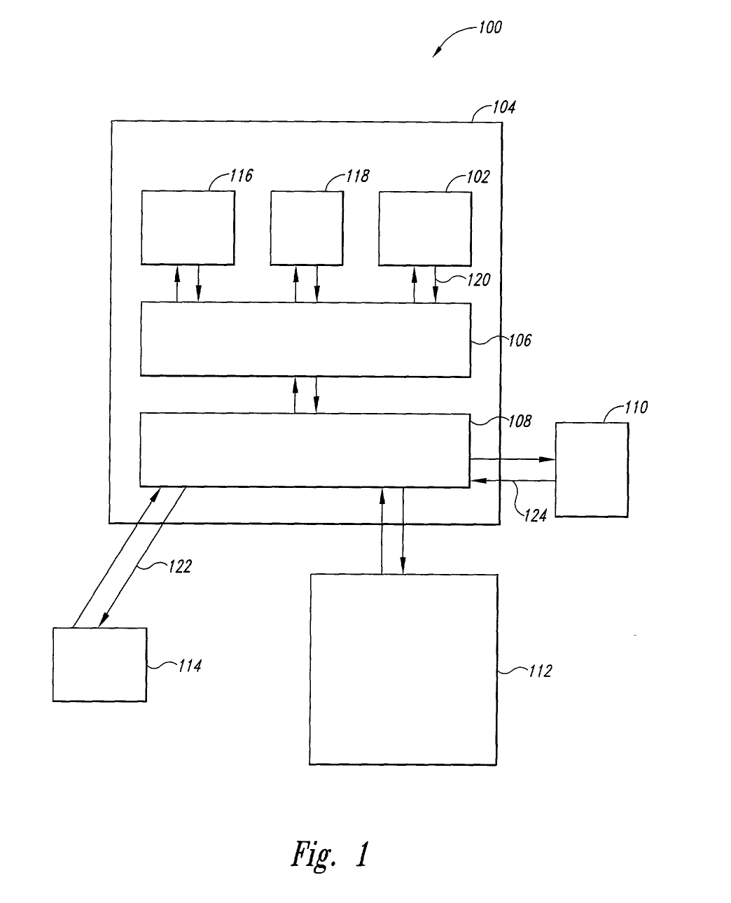

FIG. 2 illustrates a testing platform that incorporates aspects of the present invention.

FIG. 3 shows a high-level class structure for functional components surrounding the test execution engine of one implementation of a testing platform that incorporates aspects of the present invention.

FIG. 4 shows a high-level class structure for functional components surrounding a test routine in one implementation of a testing platform that incorporates aspects of the present invention.

### DETAILED DESCRIPTION OF THE INVENTION

One embodiment of the present invention is a dependency-shielded test execution engine and one or more dependency-shielded test routines that, together with a number of functional components adapted to particular hardware/hardware, hardware/software, and software/software interfaces, comprises an easily modifiable, adaptable, and portable testing platform. Any full implementation of the testing platform that represents one embodiment of the present invention greatly exceeds the scope of a concise description but, fortunately, the bulk of implementation details are straightforward and well within the implementation ability of one skilled in the art of test platform development. The present invention relates to a core architecture and a number of core concepts that enable implementation of an almost limitless number of easily modifiable, adaptable, and portable testing platform implementations. One embodiment of the present invention is described below in three subsections: (1) a high-level overview of a testing platform that incorporates the present invention; (2) a high-level, partial description of the modular organization of, and class declarations contained in, a real-life implementation of a testing platform that incorporates aspects of the present invention; and (3) an actual C++ implementation of the test execution engine of a testing platform implementation that incorporates aspects of the present invention.

### Overview

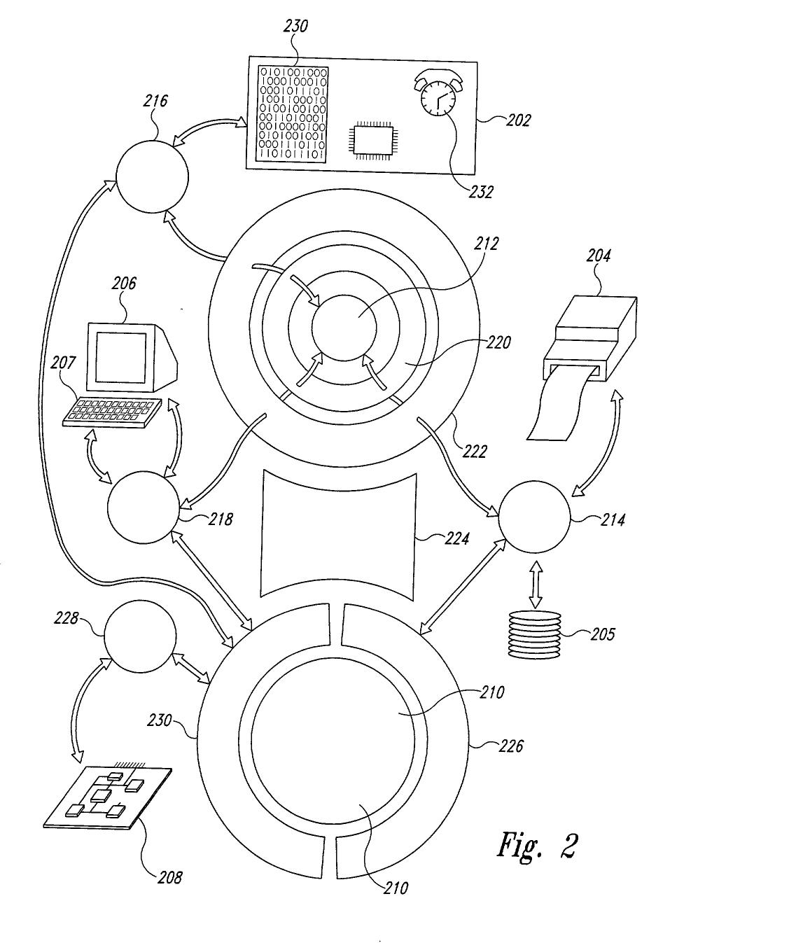

FIG. 2 illustrates a testing platform that incorporates aspects of the present invention. The computing resource and environment within which the testing platform resides include various operating-system-provided functionalities 202, data storage and output devices 204-205, user I/O devices 206-207, and, optionally, a hardware component 208 that is tested by a test routine running in association with the testing platform. A single test routine 210 is shown in FIG. 2. A testing platform incorporating the present invention may concurrently or sequentially run a large number of different testing routines, the testing routines running in an asynchronous or synchronous manner.

The testing platform includes a core test execution engine 212 that includes a central execution loop that continuously executes in order to run one or more test routines according to various user-input and programmed parameters. Both the test routine 210 and the test execution engine 212 are shielded by additional testing platform components from dependencies on the computing resources and external entities 202, 204-205, 206-207, and 208 within the environment in which the testing platform runs. The test execution engine 212 interfaces to data output and data storage devices 204-205 via a result handler component 214. The test execution engine interfaces to operating-system-provided functionality 202 via various components diagrammed together in FIG. 2 as a generalized operating system adaptor 216. The test execution engine interfaces to user I/O devices 206-207 via a user I/O component 218. The test execution engine interacts with the test routine via a mode component 220, a sequencer component 222, and a test executor component 224. The test routine 210 interfaces with the result handler component via a first test link component 226 and interfaces with the operating system adaptor, user I/O handler, and a communications interface 228 via a second test link component 230. The communications interface component 228 serves to interface the test routine 210 with a hardware component 208 tested by the test routine.

The test execution engine 212 is a centralized, core component of the testing platform. It includes the fundamental execution loop of the testing platform, and is also the location of the instantiation of class objects that represent many of the remaining functional components of the testing platform.

The mode component 220 is the main interface between the test execution engine 212 and all other components and resources of the testing platform and its computing environment. A mode defines the semantic meaning of user input to the testing platform, including input that causes the current mode to terminate and a new mode to assume its place. A testing platform may include many different instantiations of the mode class and derived mode classes or, in other words, many different mode objects. Each mode object defines the overall behavior of, and user interface to, the testing platform. The various mode classes may be related to one another through inheritance. For example, in one embodiment, a number of derivative mode classes are derived from an online-mode class, and a number of additional derivative mode classes are derived from an off-line-mode class.

The online-mode class provides an ability to update test parameters and view test description and result information. Test selection is via a cursor that moves up and down through a current page of a number of pages that describe, to a user, a suite of tests. A sequential-mode class derived from the online-mode class allows tests to be run and completed in sequence. A random-mode class derived from the online-mode class also launches test routines sequentially, but randomly varies the parameters so that, on each iteration, the test routine is called with slightly different parameters. Tests are run asynchronously under random mode. The off-line-mode class allows for complete customization of the testing platform so that, for example, an interactive hardware testing and debugging environment can be implemented.

The sequencer component 222 is, in one embodiment, implemented as a test sequencer class. As with the mode class, a number of derived test sequencer classes may be related via an inheritance tree to a parent test sequencer class. Some testing sequencer classes provide hard-coded test execution sequencing. For example, a suite of tests may be run in sequential order when one derived test sequencer class is employed, and other types of execution ordering and execution behaviors are offered by other derived test sequencer classes. For example, in another derived test sequencer class, selected tests may be continuously run until stopped by a user or by a detected error, the continuous execution ordered in various different ways. Other derived test sequencer classes allow for specialized test sequence behavior via programming. Thus, almost any test sequencing behavior can be provided by the testing platform by employing either a hard-coded derived test sequencer class or by employing a specialized, programmed test sequencer class.

The test executor component 224 provides an abstract and generalized test interface to the test sequencer component 222. The test sequencer component 222 interacts with test routines via a numerical test identifier provided by the test executor component 224. Thus, the test sequencer component 222 is shielded from interface and implementation details associated with any particular type of test routine. The test executor component 224 allows the test sequencer component 222 to interface to a variety of different types of test routines, including embedded tests that are linked together with the executable testing platform, separate executable test routines that are not linked with the testing platform executable but that are executable on the computing resources that support running of the testing platform, and external test routines that run outside the computing environment of the testing platform and that are accessed via hardware or software interfaces. Thus, the test execution engine 212 can execute a great many of different types of test routines adapted by the test executor component 224 to a common interface with the test sequencer component 222.

The results handler component 214 provides a generic interface for outputting test results to various external media, including printers 204, and hard-disk-based files and databases 205. Additional results output sinks can be easily added by including specifically adapted results handler components. The user I/O component 218 provides display handling and user input functionality. Thus, the testing platform can support an almost unlimited number of different types of user interaction, including user interaction via graphical user interfaces, consoles, and other types of user information output devices, and can select and coalesce user input from a variety of different user input devices, such as computer keyboards, touch screens, face recognition systems, and other such input devices. The operating-system-provided services interface component 216 includes various classes that provide operating-system-specific memory management 230 and timer 232 functionalities, as well as other types of operating-system-provided services. Communications interface components 228 provide interfaces to external entities accessed by the test routine 210, including external entities tested by the test routine. The test link components 226 and 230 provide to the test routine 210 a generalized interface to the testing platform, and to the functional components that make up the testing platform, shielding the test routine from testing platform details and enabling a test routine to be written easily and without dependencies on computing resource environments and testing platform internal and external interfaces.

The highly modular and onion-like layers of shielding provided by the functional components of the testing platform allow for the high levels of enhancability, adaptability, and portability of both the testing platform and of test routines developed to test various hardware and software components. The testing platform, for example, can be ported to almost any computing resource environment, including to many different operating systems and computer platforms, without the need to modify the internal execution loop within the test execution engine, nor functional components such as the test sequencer. Similarly, different test sequencing paradigms can be implemented in derived test sequencer classes without requiring notification to other functional components of the testing platform, including the test executor component 224 and the mode component 220. The basic functional components are thus implemented within distinct classes that interact through defined interfaces.

### High-Level Class Organization of One Embodiment of a Testing Platform That Incorporates Aspects of the Present Invention

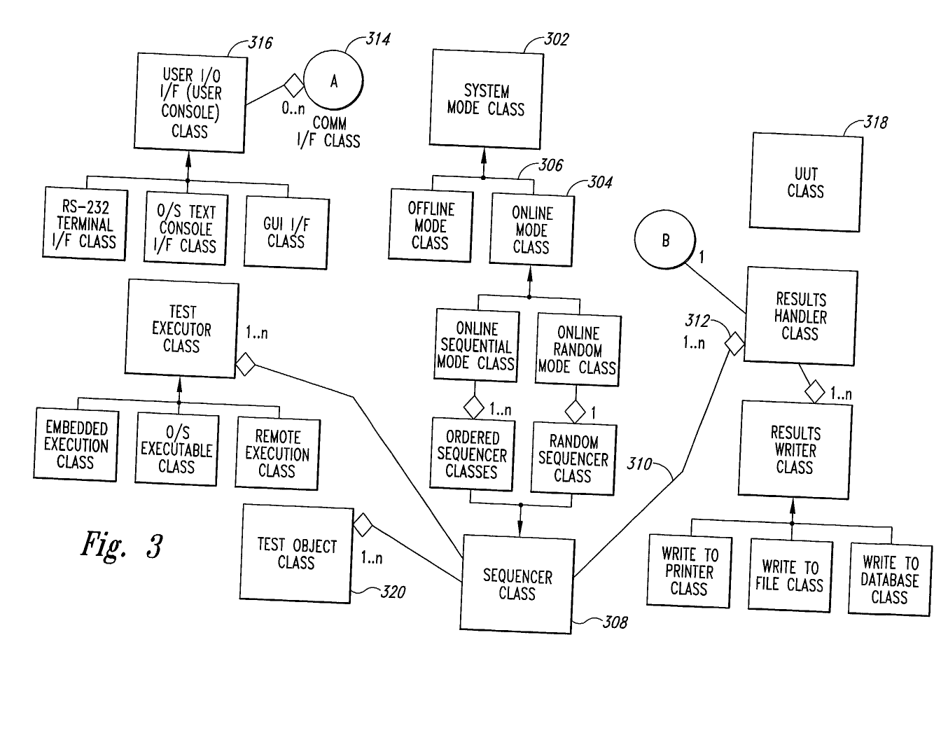

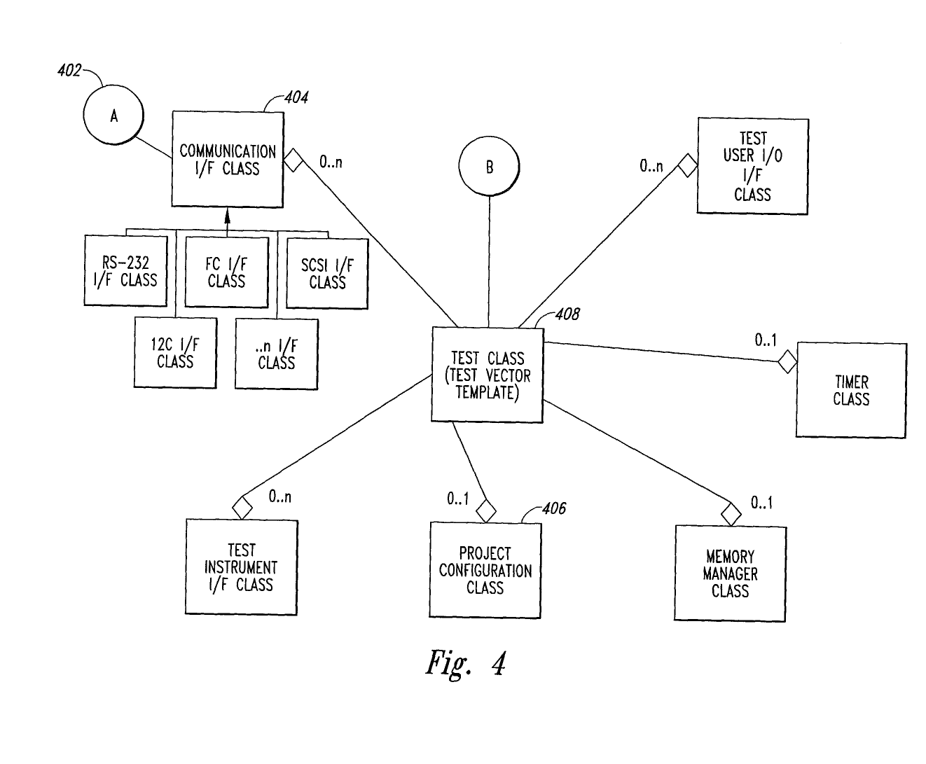

FIG. 3 shows a high-level class structure for functional components surrounding the test execution engine of one implementation of a testing platform that incorporates aspects of the present invention. FIG. 4 shows a high-level class structure for functional components surrounding a test routine in one implementation of a testing platform that incorporates aspects of the present invention.

In FIGS. 3 and 4, parent classes are shown as squares or rectangles with heavy borders, such as parent class 302. Derived classes that inherit from a parent class are shown as squares or rectangles with fine borders, such as derived class 304 in FIG. 3, with an arrow, such as arrow 306 in FIG. 3, interconnecting the derived class with the parent class and directed from the derived class to the parent class. A class that contains a number of instances of, or pointers to, another class is known as an “aggregate class,” such as, for example, aggregate class 308 in FIG. 3, and the “contains” relationship is indicated by a line, such as line 310 in FIG. 3, from the container class terminating with a small diamond-shaped object, such as diamond-shaped object 312 in FIG. 3, adjacent to the contained class. Interrelationships between classes shown in FIGS. 3 and 4 are indicated by circles with an identifying label, such as circles 402 in FIG. 4 and 314 in FIG. 3, both containing the common label “A.” Thus, the user I/O interface class 316 is an aggregate class containing a number of references or instances of the communication interface class 404.

Many of these classes shown in FIGS. 3-4 have been described above, with reference to FIG. 2. Those descriptions will not be repeated, in the interest of brevity. The UUT Class 318 contains specific textual numerical information about the units under test that may be included in output reports. The test object class 320 contains descriptive information about a test routine. The project configuration class 406 contains information about a non-volatile data storage entity. The test class 408 is an aggregate class that describes a number of different sets of test routines, incorporated within test links that allow the test routines to access user I/O components, operating-system-providing functionality components, and other functional components of the testing platform. FIGS. 3 and 4 are provided to assist an attentive reader in understanding the C++ test execution engine implementation provided in the next subsection.

### C++ Test Execution Engine Implementation

The following is an actual C++ implementation of the test execution engine component of a testing platform that incorporates concepts of the present invention. This code will be first provided below, in total, and will then be described and annotated in the text that follows:

| 1 | #define PRINT_ON1 | |
|---|---|---|
| 2 | #include “Global_defs.h” | |
| 3 | #include <iostream.h> | |
| 4 | #include “win_results_to_dax.h” | |
| 5 | #include “proj_configuration.h” | |
| 6 | #include “tlink_to_embedded_results.h” | |
| 7 | #include “programmable_sequencer.h” | |
| 8 | #include “tst_mode.h” | |
| 9 | #include “online_seq_mode.h” | |
| 10 | #include “mode_def.h” | |
| 11 | #include “Win_com.h” | |
| 12 | #include “tst_mode_defs.h” | |
| 13 | #include “online_mode_defs.h” | |
| 14 | #include “test_suite_template.h” | |
| 15 | #include “test_vec_defs.h” | |
| 16 | #include “test_object.h” | |
| 17 | #include “test_objects_map.h” | |
| 18 | #include “online_std_sequencer.h” | |
| 19 | #include “embedded_executor.h” | |
| 20 | #include “windows_executor.h” | |
| 21 | #include “test_executor_defs.h” | |
| 22 | #include “tlink_embedded_userio.h” | |
| 23 | #include “UUT_information.h” | |
| 24 | #include “UUT_defs.h” | |
| 25 | #include “results_handler.h” | |
| 26 | #include “PC_Timer.h” | |
| 27 | #include “win_tcl_tk_userio.h” | |
| 28 | #include “winnt_scsi_com.h” | |
| 29 | #include “File_print.h” | |
| 30 | #include “windows.h” | |
| 31 | #include <stdio.h> | |
| 32 | void exec_sleep(unsigned long time); | |
| 33 | void error_exit(char* msg); | |
| 34 | bool parse_input_params(int argc, char** argv, struct | |
| | MAIN_INPUT_PARAMS & | |
| 35 | | main_input_params); |

| | | |
|---|---|---|
| 36 | sys_mode_ptr | mode_ptr; |
| 37 | PC_Timer | pc_timer; |

| 38 | Test_Objects_Map test_objects_map; | |
|---|---|---|
| 39 | UUT_Information | uut_object((Timer*)&pc_timer); |
| 40 | uut_data_union | uut_data { |

| | | | |
|---|---|---|---|
| 41 | | “ManufacturingFunctionalTest”, | // Test name |
| 42 | | “123456”, | // Part number |
| 43 | | “”, | // Serial number - user entered |
| 44 | | “”, | // Host/Computer name (retrieved) |
| 45 | | “”, | // Test Slot - if applicable |
| 46 | | “1.0”, | // Test Version - if applicable |
| 47 | | “123456”, | // Product - if applicable |
| 48 | | “123456”, | // Model - if applicable |
| 49 | | “”, | // Sub Family - if applicable |
| 50 | | “”, | // Standard Operating System |
| 51 | | “”, | // Operator name\number |
| 52 | | 0 | // start tick |
| 53 | }; | | |

| 54 | char* header = “MANUFACTURING FUNCTIONAL TEST RESULTS”; | |
|---|---|---|
| 55 | int interval = 25; | |
| 56 | Proj_Configuration proj_config(“DAX_file_loc.txt”); | |
| 57 | Proj_Configuration test_file(“test_suite_file.txt”); | |
| 58 | win_com | win_rs232(“”); |
| 59 | dword | win_rs232_init[7] = |
| 60 | | {CBR_38400, FALSE, TRUE, TRUE, NOPARITY, ONESTOPBIT, |

FALSE};

| | | |
|---|---|---|
| 61 | WinNT_SCSI_Com | winnt_scsi_comm; |

| 62 | //User_IO_rs232 user_io_term(win_rs232); | |
|---|---|---|
| 63 | //User IO_Win_Console user_io_win; | |
| 64 | Win_Tcl_Tk_User_IO win_tcl_gui(0, WIN_TCL_FILE); | |
| 65 | | |
| 66 | User_IO* user_io_array[ ] = | |
| 67 | { | |
| 68 | | &win_tcl_gui, (User_IO*)0 |
| 69 | // | &win_tcl_gui, user_io_term, &user_io_win, (User_IO*)0 |
| 70 | }; | |

| | | |
|---|---|---|
| 71 | Win_Results_to_DAX | win_dax_results(uut_object, mode_ptr, user_io_array, |
| 72 | | &proj_config); |

| 73 | Results_Writer* res_dbase_array[ ] = | |
|---|---|---|
| 74 | { | |
| 75 | | &win_dax_results, (Results_Writer*)0 |
| 76 | }; | |
| 77 | /* | |
| 78 | Win_Results_to_File win_file_results(uut_object, mode_ptr, user_io_array, | |
| 79 | “win_results_file.txt”); | |
| 80 | Results_Writer* res_file_array[ ] = | |
| 81 | { | |
| 82 | | &win_file_results, (Results_Writer*)0 |
| 83 | }; | |

| | | |
|---|---|---|
| 84 | Win_Results_to_Printer | win_printer_results(uut_object, mode_ptr, |
| 85 | | user_io_array, |
| 86 | | “HP DeskJet 720C v10.3”); |

| 87 | Results_Writer* res_printer_array[ ] = | |
|---|---|---|
| 88 | { | |
| 89 | | &win_printer_results, (Results_Writer*)0 |
| 90 | }; | |
| 91 | */ | |

| 92 | //Results_Handler results_handler(test_objects_map, res_file_array, | |
|---|---|---|
| 93 | // | res_printer_array, res_dbase_array); |

| 94 | Results_Handler results_handler(test_objects_map, 0, 0, res_dbase_array); | |
|---|---|---|
| 95 | const int user_io_index = 0; | |
| 96 | Tlink_embedded_userio tlink_userio(mode_ptr, user_io_array, user_io_index); | |
| 97 | Tlink_to_Embedded_Results tlink_results(results_handler); | |
| 98 | file_print file_print_link( ); | |
| 99 | Test_Suite_Template example_test_suite(pc_timer, win_rs232, tlink_userio, | |
| 100 | | tlink_results, test_file, |
| 101 | | winnt_scsi_comm); |

| 102 | Test_Vector* template_array[ ] = | |
|---|---|---|
| 103 | { | |
| 104 | | (Test_Vector*)&example_test_suite, (Test Vector*)0 |
| 105 | // | (Test_Vector*)&simple_template, (Test_Vector*)0 |
| 106 | }; | |

| 107 | embedded_executor embed_executor(template_array); | |
|---|---|---|
| 108 | const int win_io_dex = 0; | |
| 109 | windows_executor win_executor(user_io_array, win_io_dex, mode_ptr, | |
| 110 | | results_handler, DEF_WIN32_TEST_FILE); |

| 111 | Test_Executor* executor_array[ ] = | |
|---|---|---|
| 112 | { | |
| 113 | | &embed_executor, (Test_Executor*)0 |
| 114 | | // embedded executor and windows O/S executable |
| 115 | // | &embed_executor, &win_executor, (Test_Executor*)0 |
| 116 | }; | |

| 117 | online_std_sequencer std_seq_sequencer(uut_object, test_objects_map, | |
|---|---|---|
| 118 | | executor_array, results_handler); |

| 119 | Programmable_Sequencer programmable_sequencer(uut_object, test_objects_map, | |
|---|---|---|
| 120 | | executor_array, results_handler, |
| 121 | | “sequencer.txt”); |

| 122 | tst_mode my_test_mode(DEF_KEY_FILE); | |
|---|---|---|
| 123 | online_seq_mode onl_seq_mode(test_objects_map, &std_seq_sequencer, | |
| 124 | | results_handler, uut_object, |
| 125 | | SEQ_KEY_FILE |
| 126 | | &programmable_sequencer); |

| 127 | sys_mode_ptr mode_array[ ] = | | |
|---|---|---|---|
| 128 | { | | |
| 129 | | &my_test_mode &onl_seq_mode, (sys_mode_ptr)0 | |
| 130 | }; | | |
| 131 | struct COMM_STRUCT | | |
| 132 | { | | |
| 133 | | com_if* com_ptr; | |
| 134 | | void* init_param; | |
| 135 | }; | | |
| 136 | struct COMM_STRUCT comm_array[ ] = | | |
| 137 | { | | |
| 138 | | {&win_rs232 win_rs232_init}, | |
| 139 | | {(com_if*)0, (void*)0} | |
| 140 | }; | | |
| 141 | #define OPTIONS 8 | | |
| 142 | struct MAIN_INPUT_PARAMS | | |
| 143 | { | | |
| 144 | | bool replay; | // start auto replay |
| 145 | | char uut[21]; | // UUT Part# |
| 146 | | long unsigned int virtual_port; | // virtual User I/O port |
| 147 | | char filename[81]; | // auto replay of keys file |
| 148 | | char test_mapfile[81]; | // test mapping file |
| 149 | | char pro_seq_file[81]; | // programmable sequencer file |
| 150 | | char config_file[81]; | // project specific config file |
| 151 | | char tcl_tk_gui_file[81]; | // Tck/Tk GUI Script file |
| 152 | }; | | |

| 153 | struct MAIN_INPUT_PARAMS main_input_params = | | |
|---|---|---|---|
| 154 | {FALSE,“”,0,“”,“”,“”,“”,“”}; | | |
| 155 | int main(int argc, char** argv) | | |
| 156 | { | | |
| 157 | | int ret_code; | // method return code |
| 158 | | int comm_if_dex; | // Comm I/F Object index |
| 159 | | int user_io_dex; | // User I/O Object index |
| 160 | | int res_dex | // Results writer array index |
| 161 | | int mode_dex; | // Mode Object index |
| 162 | | key_def key; | // command key |
| 163 | | bool param_ret; | // bool return value |
| 164 | | char_err_msg[DISP_TEXT_COLS+1]; | // errormessage |

| 165 | PRINT1(“Entered main( )”); | | |
|---|---|---|---|
| 166 | mode_ptr = mode_array[ONLINE_MODE_SEQ]; | | |
| 167 | ret_code = uut_object.set_uut_information(&uut_data); | | |
| 168 | if (ret_code != NO_ERR) | | |
| 169 | | error_exit(“ERROR - Writing to the UUT Object\n”); | |
| 170 | param_ret = parse_input_params(argc, argv, main_input_params); | | |
| 171 | if(param_ret) | | |
| 172 | { | | |
| 173 | | PRINT2(“replay = ”,main_input_params.replay); | |
| 174 | | PRINT2(“filename = ”,main_input_params.filename); | |
| 175 | | PRINT2(“Part# = ”,main_input_params.uut); | |
| 176 | | PRINT2(“port = ”,main_input_params.virtual_port); | |
| 177 | | PRINT2(“test mapfile = ”,main_input_params.test_mapfile); | |
| 178 | | PRINT2(“prog. sequencer file = ”,main_input_params.pro_seq_file); | |
| 179 | | PRINT2(“configuration file = ”,main_input_params.config_file); | |
| 180 | } | | |
| 181 | | if (param_ret) | |
| 182 | | { | // at least one parameter passed |
| 183 | | | ret_code = NO_ERR; |
| 184 | | | // check for auto replay file |
| 185 | | | if (strcmp(main_input_params.filename, “”)) |
| 186 | | | { |
| 187 | | | ret_code = mode_ptr−>set_filename(main_input_params.filename); |
| 188 | | | } |
| 189 | | | |
| 190 | | | //check for project configuration file |
| 191 | | | // will change the DAX location file name |
| 192 | | | if (strcmp(main_input_params.config_file, “”)) |
| 193 | | | { |
| 194 | | | ret_code \|= proj_config.set_config_name |

| | |
|---|---|
| 195 | (main_input_params.config_file); |

| | |
|---|---|
| 196 | } |

| | |
|---|---|
| 197 | // check for Programmable Sequencer file |
| 198 | if (strcmp(main_input_params.pro_seq_file, “”)) |
| 199 | { |
| 200 | ret_code \|= programmable_sequencer.set_seq_file |
| 201 | (main_input_params.pro_seq_file); |
| 202 | ret code \|= programmable_sequencer.create_sequence_table( ); |
| 203 | } |
| 204 | if (strcmp(main_input_params.test_mapfile, “”)) |
| 205 | { |
| 206 | ret_code \|= Test_Executor:: |
| 207 | set_mapfile(main_input_params.test_mapfile): |
| 208 | } |
| 209 | if (strcmp(main_input_params.tcl_tk_gui_file, “”)) |
| 210 | ret_code \|= |
| 211 | win_tcl_gui.set_gui_filename |
| 212 | (main_input_params.tcl_tk_gui_file); |
| 213 | if (main_input_params.replay) |
| 214 | { |
| 215 | ret_code \|= mode_ptr−>get_saved_keys_from_file( ); |
| 216 | ret_code \|= mode_ptr−>replay_saved_keys( ); |
| 217 | ret_code \|= mode_ptr−> |
| 218 | display_msg_line |
| 219 | (L_STATUS_STRING, REPLAYED, user_io_array); |
| 220 | } |
| 221 | |
| 222 | if(strcmp(main_input_params.uut, “”)) |
| 223 | { |
| 224 | PRINT2(“UUT # Passed = ”,main_input_params.uut); |
| 225 | ret_code \|= uut_object.get_uut_information(uut_data); |
| 226 | strcpy(uut_data.p_uut_data.partnum,main_input_params.uut); |
| 227 | ret_code \|= uut_object.set_uut_information(&uut_data); |
| 228 | } |
| 229 | if(main_input_params.virtual_port != 0) |
| 230 | { |
| 231 | PRINT2(“Virtual Port # Passed = ”, |
| 232 | main_input_params.virtual_port); |
| 233 | ; |
| 234 | } |
| 235 | if (ret_code != NO_ERR) |
| 236 | error_exit(“ERROR with Input Parameter(s) |
| 237 | handling routine(s)\n”); |
| 238 | } |
| 239 | comm_if_dex = 0; |
| 240 | |
| 241 | PRINT1(“INITIALIZING THE USER I/O's, |
| 242 | PLEASE WAIT, IT TAKES A FEW SECONDS....”), |
| 243 | user_io_dex = 0 |
| 244 | while ( user_io_array[user_io_dex] != (User IO*)0 ) |
| 245 | { |
| 246 | ret_code = |
| 247 | user_io_array[user_io_dex++]−>initialize_user_io((void*)0); |
| 248 | if (ret code != NO_ERR) |
| 249 | error_exit(“ERROR - Initializing User I/O object\n”); |
| 250 | } |
| 251 | PRINT1(“User I/O Objects Initialized okay”); |
| 252 | mode_dex = 0; |
| 253 | while ( mode_array[mode_dex] != (sys_mode_ptr)0 ) |
| 254 | { |
| 255 | ret_code = mode_array[mode_dex]−>initialize_mode(user_io_array); |
| 256 | if(ret code != NO_ERR) |
| 257 | error_exit(“ERROR - Initializing System Mode object\n”); |
| 258 | // pass the UUT object to the System Mode |
| 259 | mode_array[mode_dex]−>set_UUT_object(&uut_object); |
| 260 | ++mode_dex |
| 261 | } |
| 262 | PRINT1(“Mode Objects Initialized okay”); |
| 263 | res_dex = 0; |
| 264 | while ( res_dbase_array[res_dex] != (Results_Writer*)0) |
| 265 | { //init the results to dbase objects and send header info |
| 266 | ret_code = res_dbase_array[res_dex]−>send_header(header, interval); |
| 267 | ret_code = res_dbase_array[res_dex++]−>open((void*)0); |
| 268 | if(ret_code != NO_ERR) |
| 269 | error_exit(“ERROR - Initializing Dbase Results |
| 270 | Writer Object\n”); |
| 271 | } |
| 272 | PRINT1(“Dbase Result Writer Objects Initialized okay”); |

| 273 | /*** | |
|---|---|---|
| 274 | | res_dex = 0 |
| 275 | | while (res_file array[res_dex] != (Results_Writer*)0) |
| 276 | | { //init the results to file objects and send header info |
| 277 | | ret_code = res_file_array[res_dex]−>send_header(header, interval); |
| 278 | | ret_code = res_file_array[res_dex++]−>open((void*)0); |
| 279 | | if (ret_code != NO_ERR) |
| 280 | | error exit(“ERROR - Initializing File |
| 281 | | Results Writer Object\n”); |
| 282 | | } |
| 283 | | PRINT1(“File Result Writer Objects Initialized okay”); |
| 284 | | res_dex = 0; |
| 285 | | while (res_printer_array[res_dex] != (Results_Writer*)0 ) |
| 286 | | { |
| 287 | | ret_code = res_printer_array[res_dex]−>send_header(header, 0); |
| 288 | | ret_code = res_printer_array[res_dex]++]−>open((void*)0); |
| 289 | | if(ret_code != NO_ERR) |
| 290 | | error_exit(“ERROR - Initializing Printer |
| 291 | | Results Writer Object\n”); |
| 292 | | } |
| 293 | | PRINT1(“Printer Result Writer Objects Initialized okay”); |
| 294 | ***/ | |
| 295 | | ret_code = mode_ptr−>display_main_screen(user_io_array); |

| | |
|---|---|
| 296 | user_io_dex = 0 |

| | |
|---|---|
| 297 | while (TRUE) |
| 298 | { |
| 299 | if (user_io_array[user_io_dex] == (User_IO*)0) |
| 300 | user_io_dex = 0; |
| 301 | ret_code = mode_ptr−>get_command(user_io_array[user_io_dex], key); |
| 302 | |
| 303 | if(ret_code == NO_ERR) |
| 304 | { |
| 305 | ret_code = mode_ptr−>verify_general_cmd(key); |
| 306 | if(ret_code == NO_ERR) |
| 307 | { |
| 308 | ret_code = |
| 309 | mode_ptr−>execute_general_cmd(user_io_array, |

| | |
|---|---|
| 310 | user_io_dex, key, |
| 311 | mode_ptr, |
| 312 | mode_array); |
| 313 | |

| | |
|---|---|
| 314 | if (ret_code == EXIT_EXEC) |
| 315 | { |
| 316 | results_handler.signal_end_results( ); |
| 317 | break; |
| 318 | } |
| 319 | } |
| 320 | else |
| 321 | { |
| 322 | ret_code = mode_ptr−>verify_custom_cmd(key); |
| 323 | if(ret_code == NO_ERR) |
| 324 | { |
| 325 | ret_code = mode_ptr−>execute_custom_cmd( |
| 326 | user_io_array, user_io_dex, key); |
| 327 | } |
| 328 | else |
| 329 | { |
| 330 | sprintf(err_msg, “Key/Command ‘%c’ NOT supported”, |
| 331 | key); |
| 332 | ret_code = |
| 333 | mode_ptr−>display_msg_line(L_ERROR_STRING, |

| | |
|---|---|
| 334 | err_msg, |
| 335 | user_io_array); |

| | | |
|---|---|---|
| 336 | | } |
| 337 | | } |
| 338 | | } |
| 339 | | ret_code = mode_ptr−>execute_next_mode_op(user_io_array); |
| 340 | | user_io_dex++; |
| 341 | | exec_sleep(100); |
| 342 | | } |
| 343 | | return(0); |
| 344 | } | |

The above C++ test execution engine code is taken from an actual testing platform implementation, and thus includes many details tangential to the present invention. However, for the sake of completeness, the entire module is provided, above. In the following discussion, the module is described with particular emphasis on those portions of the code that relate to aspects of the present invention described in the previous overview and class-description subsections.

Lines 1-31 include C++ include directives that import a number of header files that contain class definitions for many of the classes described above, in the previous subsections. The broad functionality provided by those classes, as described above, is pertinent to a description of the current invention, but implementation details and specifics of the class definitions are outside the scope of the present discussion.

On lines 32-35, three C-function prototypes are provided. Their effects will be described later, at the point that they are called.

Next, an extended section of global object instantiations begins on line 36.. The global object “mode_ptr,” instantiated on line 36, is a global reference to the currently active mode of the testing platform, corresponding to the mode component 220 in FIG. 2. The global object “pc_timer,” instantiated on line 37, is a system timer corresponding to timer 232 in FIG. 2 packaged within one of the many functional components represented in aggregate by functional component 216 in FIG. 2. The global “test_objects_map,” instantiated on line 38, is a container object that contains a descriptive test object for each test run by the testing platform. The global object “uut_object,” instantiated on line 39, contains descriptive information concerning the component under test by the testing platform, including the descriptive information within the union “uut_data,” instantiated on lines 40-53. The global character string referenced by the pointer “header,” declared on line 54, is a header string output to result files after output of each group of test results, where the size of a group of test results is defined by the global “interval,” declared on line 55. The globals “proj_config” and “test_file,” instantiated on lines 56 and 57, specify disk files used for non-volatile storage of database data and test data, respectively. Several communications interface objects, corresponding to instances of the functional component 228 in FIG. 2, are instantiated and initialized on lines 58-61. Several user I/O components, representing instances of functional component 218 in FIG. 2, are instantiated on lines 62-64, with several instantiations commented out in the current implementation because they are not used. Global array “user io array” is declared and initialized on lines 66-70. This array contains pointers to user I/O objects that interface the testing platform to various user I/O interfaces.

On lines 71-91, a number of Results_Writer objects are instantiated for handling results outputs to databases, disk files, and printers. Certain of these instantiations are commented out, because the functionality is not required in the current implementation. The commented-out instantiations have been left in the code in order to demonstrate how such Results_Writer objects would be included, if needed. On line 94, the global “results_handler” is instantiated. This Results_Handler instance corresponds to the functional component 214 in FIG. 2, and is responsible for interfacing the testing platform to all data output interfaces, including interfaces to databases, files, and printers. On line 95, the global “user_io_index” is initialized to zero.

The Tlink objects “tlink_results” and “tlink_user_io,” instantiated above on lines 97 and 96, respectively, correspond to the functional components 226 and 230 in FIG. 2. These Ttink objects are used by test routines to interface to testing platform functional components, including the communications interface components, user I/O components, and result handler components. The Tlink object “tlink_user_io” is passed the global “user_io_index” to indicate that a test routine using this Tlink object uses the first user I/O object in the array “user_io_array” for input. The global function “file_print_link( ),” declare on line 98, is an event log that testing platform developers can use to log various developer-defined events during debugging and analysis of the testing platform.

The global “example_test_suite,” instantiated on lines 99-101, represents a suite, or set, or test routines linked to the testing platform. The array “template_array,” declared and initialized on lines 102-106, include references to the suites, or sets, of test routines that will be run by the testing platform. Grouping of test routines into suites allows the testing platform to supply different ordering and execution paradigms to the test routines of each different test suite.

Test_executor objects are instantiated on lines 107-110. Each test_executor object corresponds to functional component 224 in FIG. 2. The array “executor_array,” declared and initialized on lines 111-116, includes references to the various different test_executor objects instantiated for the testing platform. As described above, a test_executor object interfaces the testing platform to test routines of particular types, the types including embedded tests that are linked together with a testing platform code, test routines that are separate executable programs that run on the computing resources environment in which the testing platform runs, and external test routines that may run on remote computers or that may represent external hardware devices under test.

A number of different sequencer objects, each corresponding to functional component 222 in FIG. 2, are instantiated on lines 117-121. These objects isolate test-sequencing details from the mode objects, and allow interchange of various different sequencings of test routine execution. Two sequencer objects are instantiated: a standard sequencer is instantiated on lines 117-118 and a programmable sequencer instantiated on lines 119-121.

A number of different system mode objects, each responding to functional component 220 in FIG. 2, are instantiated on lines 122-126. References to these system mode objects are then included in the array “mode_array,” declared and initialized on lines 127-130. This array contains references to the different instantiated mode objects that may define operation and behavior of the testing platform, as described above.

On lines 131-140, initialization parameters for communications interface objects are stored in global structures. Values of input parameters to the test execution engine are described by the structure “MAIN_INPUT_PARAMS,” declared on lines 142-152. An instance of this structure is initialized to default values on lines 153-154, and is later passed to a parsing routine that extracts values from arguments supplied to the test execution engine “main” routine.

Finally, the test execution engine is provided on lines 155-344. On lines 157-164, local variables for the test execution engine are declared. The local “user_io_dex,” declared on line 159, is used by the test execution engine to continuously iterate through the user I/O objects contained in the array “user_io_array,” declared above on line 66. On line 166, the global “mode_pointer” is initialized to point to the online mode object contained within the array “mode_array.” On line 167, the global “uut_object” is initialized using data stored in the global union “uut_data.” On line 170, the C routine “parse_input_params” is called to parse the parameters supplied to the test execution engine. A long section, including lines 171-238, involves checking and verifying the parsed parameters and taking various actions depending on the parameter state. For example, actions may be taken to elicit input of parameters initially input in an incorrect format or with values outside reasonable or expected ranges. On lines 239-295, various global objects corresponding to functional components of the testing platform, described with reference to FIG. 2, are initialized.

The internal execution loop for the test execution engine is provided on lines 296-344. This short section of C++ code represents the basic, core event handling loop within the testing platform. The fact that the test execution engine can be so concisely specified in C++ is a testament to the effectiveness of the dependency shielding provided by the functional components surrounding the test execution engine.

On line 296, the local index “user_io_dex” is initialized to zero. Then, the test execution engine continuously operates, within the infinite while-loop of lines 297-342, until interrupted by a termination event. The while-loop continuously traverses the array “user_io_array” to check each user I/0 object for input to the testing platform. After each iteration of the while-loop, the index “user_io_dex” is incremented on line 340. If the index is incremented past the end of the I/O objects within the array “user_io_array,” as detected on line 299, the index “user_io_dex” is reinitialized to reference the first user I/O object with the array on line 300. On line 301, the mode member function “get_command” is used to interpret any input, available from the user I/O object currently indexed by index “user_io_dex,” as a command, and that command is stored in the local variable “key.” If the user I/O object had input interpretable by the mode object referenced by the global “mode_ptr,” as detected by the test execution engine on line 303, then, on line 305, the mode member function “verify_general_cmd” is called to determine whether the input command is a general command. If so, as detected by the test execution engine on line 306, the mode member function “execute_general_cmd” is called, on line 309, to carry out the general command. Note that a general command may result in a change of active modes, necessitating passing of the pointer “mode_ptr” to member function “execute_general_cmd.” If, as a result of execution of the general command, a termination event occurs, forcing termination of the test execution engine, as detected on line 314 by the test execution engine, an indication of the termination is output via the results handler on line 316 and the while-loop is terminated on line 317. If the command entered via the user I/O object is a custom command, as determine on lines 322-323, then the mode member function “execute_custom_cmd” is called on line 325 to process the custom command. If the input from the user I/O object cannot be interpreted by the mode object as either a general command or a custom command, then an error message is displayed to the user on lines 330-335. On line 339, the test execution engine executes a next system-mode operation by calling the mode member function “execute_next_mode_op.” This next system-mode operation depends on the currently active system mode, or, in other words, on the contents of global reference “mode_ptr.” Different types of system modes provide different functionalities via system-mode operations. After incrementing the next “user_io_dex” on line 340, the test execution engine calls the C function “exec_sleep” on line 341 in order to pause to allow other computational activity concurrently executing with the testing platform to run within the computing resource environment. The call to exec_sleep is therefore, essentially, a yield operation. When the test execution engine loop is terminated by the call to the C++ directive break on line 317, the test execution engine completes via the statement “return(0)” on line 343.

Although the present invention has been described in terms of a particular embodiment, it is not intended that the invention be limited to this embodiment. Modifications within the spirit of the invention will be apparent to those skilled in the art. For example, an almost limitless number of different implementations of a testing platform that incorporates the present invention are possible, with different modular organizations, control structures, and data structures, and written in any of many different programming languages. The testing platform architecture described above is extremely flexible, allowing for derivation of classes corresponding to functional components in order to adapt the testing environment to new types of test routines, new or different types of communications interfaces, new or different types of result output sinks, including printers, display devices, databases, files, and other such data sinks, to new and different user I/O devices and paradigms, and to new and different computing resource environments, including hardware platforms and operating systems. Shielding of the test execution engine and test routines from hardware and software dependencies may also be accomplished in an almost limitless number of ways.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A testing platform within a computing resource environment, the testing platform comprising:
a test execution engine that receives input commands and initiates processing of the input commands;
a test routine; and
components that serve to adapt hardware and software interfaces of the computing resource environment to the test execution engine and test routine and that shield the test execution engine and test routine from dependencies on the hardware and software interfaces of the computing resource environment.

2. The testing platform of claim I wherein the hardware and software interfaces of the computing resource environment include interfaces to external hardware components and peripherals, external data storage and data I/O devices, communications hardware, operating system interfaces, and software interfaces to programs and routines.

3. The testing platform of claim 2 wherein the components that serve to adapt hardware and software interfaces of the computing resource environment to the test execution engine include:
user I/O components that adapt the test execution engine to user I/O interfaces;
result handling components that adapt the test execution engine to data output and presentation interfaces, including interfaces to disk files, printers, and databases; and
computing resource components that adapt the test execution engine to operating system interfaces, including memory management interfaces and timer interfaces.

4. The testing platform of claim 2 wherein the testing platform can concurrently include and employ multiple user I/O components, multiple result handling components, and multiple computing resource components.

5. The testing platform of claim 2 wherein the components that serve to adapt hardware and software interfaces of a computing resource environment to the test routine include:
user I/O components that adapt the test routine to user I/O interfaces;
result handling components that adapt the test routine to data output and presentation interfaces, including interfaces to disk files, printers, and databases;
computing resource components that adapt the test routine to operating system interfaces, including memory management interfaces and timer interfaces; and
communications components that adapt the test routine to communications interfaces.

6. The testing platform of claim 5 wherein the testing platform can concurrently include and employ multiple user I/O components, multiple result handling components, multiple computing resource components, and multiple communications components.

7. The testing platform of claim 1 further including components that adapt the test execution engine to the test routine and that adapt the test routine to the test execution engine.

8. The testing platform of claim 7 wherein the components that adapt the test execution engine to the test routine include:
a test executor component that adapts the test execution engine to a test routine linked to test platform object code in a common executable;
a test executor component that adapts the test execution engine to a separate test routine executable that runs within the computing resource environment; and
a test executor component that adapts the test execution engine to an external test routine.

9. The testing platform of claim 7 wherein the components that adapt the test routine to the test execution engine include:
test link components that adapt the test routine to user I/O components, result handling components, computing resource components, and communications components.

10. The testing platform of claim I wherein multiple test routines can be concurrently handled by the test platform, and may be executed:
concurrently;
sequentially;
synchronously;
asynchronously; and
according to programmed execution patterns.

11. The testing platform of claim 10 wherein a test sequencing component handles launching and execution behavior of groups of test routines.

12. The testing platform of claim I wherein a mode component interprets user input as testing platform commands and dispatches appropriate routine calls to execute testing platform commands.

13. The testing platform of claim 12 wherein multiple mode components are included in the testing platform, with a single mode component active at each instant in time.

14. The testing platform of claim 13 wherein deactivation of a mode component and activation of another mode component may be elicited by an input command.

15. A method for flexibly, extensibly, and portably testing components, the method comprising:
providing a component to test;
developing a test routine that tests the component, shielding the test routine from dependencies on hardware and software interfaces by employing interfaces to adapter components within the test routine; and
running the test routine from a testing platform that includes a test execution engine shielded from dependencies on hardware and software interfaces by employing interfaces to adapter components within the test execution engine.

16. The method of claim 15 wherein employing interfaces to adapter components within the test routine further includes:
employing interfaces to user I/O components that adapt the test routine to user I/O interfaces;
employing interfaces to result handling components that adapt the test routine to data output and presentation interfaces, including interfaces to disk files, printers, and databases;
employing interfaces to computing resource components that adapt the test routine to operating system interfaces, including memory management interfaces and timer interfaces; and
employing interfaces to communications components that adapt the test routine to communications interfaces.

17. The method of claim 15 wherein employing interfaces to adapter components within the test execution engine further includes:
employing interfaces to user I/O components that adapt the test execution engine to user I/O interfaces;
employing interfaces to result handling components that adapt the test execution engine to data output and presentation interfaces, including interfaces to disk files, printers, and databases; and
employing interfaces to computing resource components that adapt the test execution engine to operating system interfaces, including memory management interfaces and timer interfaces.

18. The method of claim 15 further including:
employing interfaces to adapter components within the test execution engine that adapt the test execution engine to the test routine; and
employing interfaces to adapter components within the test routine that adapt the test routine to the test execution engine.

19. The method of claim 18 wherein employing interfaces to adapter components within the test execution engine that adapt the test execution engine to the test routine further includes:
employing interfaces to test executor components that adapt the test execution engine to a test routine linked to test platform object code in a common executable;
employing interfaces to test executor components that adapt the test execution engine to separate test routine executables; and
employing interfaces to test executor components that adapt the test execution engine to external test routines.

20. The method of claim 18 wherein employing interfaces to adapter components within the test routine that adapt the test routine to the test execution engine further includes:
employing interfaces to test link components that adapt the test routine to user I/O components, result handling components, computing resource components, and communications components.

21. The method of claim 15 further including employing within the test execution engine an interface to a test sequencing component that handles launching and execution orderings and synchronicities of groups of test routines.

22. The method of claim 15 further including employing within the test execution engine an interface to a mode component that interprets user input as testing platform commands and dispatches appropriate routine calls to execute testing platform commands.
